(19) United States
(12) Patent Application Publication
(10) Pub. No.: US 2023/0367929 A1
(43) Pub. Date: Nov. 16, 2023

(54) OPTIMISATION FO ALLOY PROPERTIES

(71) Applicants: National University of Singapore, Singapore (SG); The Regents of the University of California, Oakland, CA (US)

(72) Inventors: Manoj Gupta, Singapore (SG); Khin Sandar Tun, Singapore (SG); Chih-Ming Ho, Los Angeles, CA (US); Jeffrey Huy Khong, Anaheim, CA (US)

(21) Appl. No.: 18/245,045

(22) PCT Filed: Sep. 16, 2021
(86) PCT No.: PCT/SG2021/050562

§ 371 Date: Mar. 13, 2023

Related U.S. Application Data
(60) Provisional application No. 63/079,858, filed on Sep. 17, 2020.

(51) Int. Cl. G06F 30/20; C22C 1/02; C22C 23/00; C22C 23/02; C22F 1/06; B22D 21/00

(52) U.S. Cl. CPC G06F 30/20; C22C 1/02; C22C 23/00; C22C 23/02; C22F 1/06; B22D 21/007

(57) ABSTRACT

A method of optimising one or more physical properties of an alloy comprises conducting a plurality of trials per an experimental design on a plurality of candidate alloys. Each trial comprises measuring a plurality of values of each physical property of the candidate alloys for different values of a plurality of parameters, wherein the parameters comprise respective concentrations of the two or more constituents, and one or more process parameters. The method further comprises fitting the plurality of values of the physical property and the plurality of parameters to a response surface model; and determining, from the fitted response surface model, optimised values of the parameters that optimise the respective responses; wherein the response surface model describes a non-linear relationship between a time integral of each of the physical property and a linear combination of non-linear functions of the plurality of parameters.

### TECHNICAL FIELD

The present disclosure relates to methods and systems for optimisation of alloy properties, and to methods of manufacture of alloys that have optimised properties.

### BACKGROUND

The properties of modern materials are often tailored for a specific application. Conventionally, material properties are tailored to achieve targeted or desired properties by using traditional trial-and-error methods. In the case of structural applications, the best combination of strength and ductility is of importance. One structural metal, aluminium (Al), is intrinsically ductile, but is not strong enough for many intended structural applications. Hence it is typical to enhance the strength of Al by alloying it with elements such as magnesium (Mg) and Zinc (Zn). Mechanical properties of various Al alloys can be optimised by using different alloying elements as well as by varying the concentrations of the alloying elements.

Depending on the application area, material properties need to be tailored to be fit for purpose. For example, in biomedical applications, the properties of the implant materials should be designed to be suitable to replace the intended body part, such as bones or teeth. In electronic applications, the device materials must have the best possible electromagnetic shielding capability and high damping capacity. Optimisation of various properties of metal based alloys is generally achieved by experimentation and trial-and-error methods.

For commercial production of certain alloy systems, the impurity level of raw materials (base metals and alloying elements) can greatly influence the properties of the fabricated alloys. The impurities vary from batch to batch of a supplier and also vary between different raw material suppliers. This is a source of inconsistencies and is hard to manage.

The same alloy with exactly the same composition may have different properties if different processing and/or manufacturing methods are used to produce it. For example, the alloy may have optimal properties when produced using liquid metallurgy, but the same properties may not be achieved if powder metallurgy is used. In addition, optimal processing parameters are important to produce alloys with optimal properties. The processing parameters are not only limited to primary processing parameters such as heating rate, cooling rate, holding time, stirring time etc. They also include processing parameters for post treatment on alloys such as solution temperature, solution time, ageing temperature and ageing time etc. Besides processing methods, the application of secondary or post processing methods such as extrusion and rolling can also be used to enhance the properties of materials. It is also desirable to have optimal processing parameters for secondary processing methods. Hence, the more parameters that are required to achieve the optimal properties, the more cumbersome the combinations. This leads to a waste of resources, time and cost.

It would be desirable to address or alleviate one or more of the above issues.

### SUMMARY

The present disclosure relates to a method of optimising one or more physical properties of an alloy that comprises two or more constituents, the method comprising:
conducting a plurality of trials in accordance with an experimental design, on a plurality of candidate alloys,
wherein each trial comprises, for each physical property of the one or more physical properties, measuring a plurality of values of the respective physical property of the candidate alloys for different values of a plurality of parameters,
wherein the parameters comprise respective concentrations of the two or more constituents, and one or more process parameters;
fitting the plurality of values of the physical property or properties and the plurality of parameters to a response surface model, in which respective physical properties are respective responses and the parameters are the predictors; and
determining, from the fitted response surface model, optimised values of the parameters that optimise the respective responses;
wherein the response surface model describes a non-linear relationship between a time integral of the physical property and a time integral of a linear combination of non-linear functions of the plurality of parameters.

In some embodiments, said determining comprises a multi-objective optimisation.

In some embodiments, the one or more process parameters comprise a plurality of process parameters for a plurality of different processes for generating the candidate alloys. For example, the plurality of different processes may comprise one or more primary processing methods and one or more secondary processing methods.

In some embodiments, the one or more process parameters are selected from the group consisting of: heating rate, cooling rate, holding time, stirring time, solution temperature, solution time, ageing temperature and ageing time.

In some embodiments, the response surface model is: ∫_{T}_{₀}^{T}E(C,t)dt=∫_{T}_{₀}^{T}x₀(t)dt+Σᵢ₌₁^{M}∫_{T}_{₀}^{T}xᵢ(cᵢ, t)cᵢ(t)dt+Σᵢ₌₁^{M}∫_{T}_{₀}^{T}xᵢᵢ(cᵢᵢ,t)cᵢ²(t)dt+Σᵢ₌₁^{M-1}Σⱼ₌ᵢ₊₁^{M}∫_{T}_{₀}^{T}xᵢⱼ(cᵢⱼ,t)cᵢ(t)cⱼ(t)dt,
where T₀ is a start time, T is a process end time, cᵢ(t) quantifies an i^{th} parameter at time t, cⱼ(t) quantifies a j^{th} parameter at time t, M is a number of parameters and cᵢⱼ(t) represents an interaction between the i^{th} and j^{th} parameters.

Some embodiments of the method further comprise manufacturing the alloy in accordance with the optimised values of the parameters.

The present disclosure also relates to a system for optimising one or more physical properties of an alloy that comprises two or more constituents, the system comprising: one or more processors in communication with computer-readable storage having stored thereon instructions for causing the one or more processors to carry out an optimisation process comprising:
obtaining data from a plurality of trials, that are conducted in accordance with an experimental design, performed on a plurality of candidate alloys, wherein each trial comprises, for each physical property of the one or more physical properties, measuring a plurality of values of the physical property for different values of a plurality of parameters, the plurality of parameters comprising respective concentrations of the two or more constituents and one or more process parameters;
fitting the plurality of values of the physical property and the plurality of parameters to a response surface model, in which the physical property is the response and the parameters are the predictors; and
determining, from the fitted response surface model or fitted response surface models, optimised values of the parameters that optimise the response or the responses;
wherein the response surface model describes a non-linear relationship between a time integral of the physical property and a time integral of a linear combination of non-linear functions of the plurality of parameters.

Said determining may comprise a multi-objective optimisation.

The one or more process parameters may comprise a plurality of process parameters for a plurality of different processes for generating the candidate alloys, such as one or more primary processing methods and one or more secondary processing methods.

In some embodiments, the one or more process parameters are selected from the group consisting of: heating rate, cooling rate, holding time, stirring time, solution temperature, solution time, ageing temperature and ageing time.

In some embodiments the response surface model is: ∫_{T}_{₀}^{T}E(C,t)dt=∫_{T}_{₀}^{T}x₀(t)dt+Σᵢ₌₁^{M}∫_{T}_{₀}^{T}xᵢ(cᵢ, t)cᵢ(t)dt+Σᵢ₌₁^{M}∫_{T}_{₀}^{T}xᵢᵢ(cᵢᵢ,t)cᵢ²(t)dt+Σᵢ₌₁^{M-1}Σⱼ₌ᵢ₊₁^{M}∫_{T}_{₀}^{T}xᵢⱼ(cᵢⱼ,t)cᵢ(t)cⱼ(t)dt,
where T₀ is a start time, T is a process end time, cᵢ(t) quantifies an i^{th} parameter at time t, cⱼ(t) quantifies a j^{th} parameter at time t, M is a number of parameters and cᵢⱼ(t) represents an interaction between the i^{th} and j^{th} parameters.

The present disclosure further relates to non-transitory computer-readable storage having stored thereon instructions for causing one or more processors to carry out an optimisation process comprising:
obtaining data from a plurality of trials that are conducted in accordance with an experimental design to generate a plurality of candidate alloys, wherein each trial comprises, for each physical property of the one or more physical properties, measuring a plurality of values of the physical property for different values of a plurality of parameters, the plurality of parameters comprising respective concentrations of the two or more constituents and one or more process parameters;
fitting the plurality of values of the physical property and the plurality of parameters to a response surface model, in which the physical property is the response and the parameters are the predictors; and
determining, from the fitted response surface model or fitted response surface models, optimised values of the parameters that optimise the response or the responses;
wherein the response surface model describes a non-linear relationship between a time integral of the physical property and a time integral of a linear combination of non-linear functions of the plurality of parameters.

The present disclosure further relates to a method of manufacturing an alloy, comprising: determining optimised parameter values by a method as disclosed herein; and manufacturing the alloy in accordance with the optimised parameter values.

### BRIEF DESCRIPTION OF THE DRAWINGS

Some embodiments of a method and system for optimizing alloy properties, in accordance with present teachings will now be described, by way of non-limiting example only, with reference to the accompanying drawings in which:

FIG. 1 is a flow diagram of an exemplary method for optimising alloy properties;

FIG. 2 is a block diagram of an example system for optimising alloy properties;

FIG. 3 shows parabolic response surface curves of an alloy of Mg, Al, and Li, and regions of weight percentage values for the constituents of the alloy that produce optimal compressive yield strength; and

FIG. 4 illustrates a method of optimising one or more physical properties of an alloy that comprises two or more constituents.

### DETAILED DESCRIPTION

Embodiments of the present disclosure are directed to optimisation of alloy properties, such as tensile/compressive strength, and determination of manufacturing parameters (or ranges thereof) that result in the optimised properties. Such manufacturing parameters comprise not only the proportions of the elements to be alloyed, but also processing parameters such as heating rate and cooling rate, post-treatment parameters such as solution temperature and solution time, and parameters of post-processing (secondary processing) methods such as extrusion and rolling.

Embodiments of this disclosure are based on a surprising finding that a complex process that depends on multiple input parameters can be represented by a low order function, such as a second order (or quadratic) function, or a first order (or linear) function.

By leveraging this surprising finding, a relatively small number of experimental tests can be conducted to model a response surface for a mechanical property of an alloy as a function of a plurality of parameters, and this input/output (predictor/response) model can be used to identify optimised combinations of elements and their concentrations, and process parameters for the alloy manufacturing process.

In the case of optimising mechanical properties, a mechanical property E can be one or more of compressive stress and strain, tensile stress and strain or microstructural properties, and parameters cᵢ comprise the concentrations of interacting alloy components. E is related to cᵢ by a parabolic response surface, which is represented by Function (1). As the interactions are time dependent, the function representing the model is as follows:

$${\int }_{{T}_{0}}^{T} E ( C , t ) dt = {\int }_{{T}_{0}}^{T} {x}_{0} ( t ) d t + {\sum }_{i = 1}^{M} {\int }_{{T}_{0}}^{T} {x}_{i} ( {c}_{i} , t ) {c}_{i} ( t ) d t + {\sum }_{i = 1}^{M} {\int }_{{T}_{0}}^{T} {x}_{i i} ( {c}_{ii} , t ) {c}_{i}^{2} ( t ) dt + {\sum }_{i = 1}^{M - 1} {\sum }_{j = i + 1}^{M} {\int }_{{T}_{0}}^{T} {x}_{ij} ( {c}_{i j} , t ) {c}_{i} ( t ) {c}_{j} ( t ) dt \qquad ( 1 )$$

In Formula (1), T₀ is the start time, T is a process end time, cᵢ(t) quantifies the i^{th} parameter at time t, cⱼ(t) quantifies the j^{th} parameter at time t, M is the number of parameters and cᵢⱼ(t) represents an interaction between the i^{th} and j^{th} parameters—e.g. molecular scale interactions between two or more (and potentially all) elements, components and impurities, microstructure properties, homogeneities of mixing and so on. For example, cᵢ may be the weight percentage of a particular element (or group of elements) in the alloy and cᵢⱼ of may be the molecular scale interactions between that particular element and a j^{th} element or impurity. Other parameters may include process parameters such as heating rate, cooling rate, holding time, stirring time, solution temperature, solution time, ageing temperature and ageing time.

The coefficients, xᵢ or xᵢᵢ, are functions of time, the reaction efficiencies of the interacting elements, molecular scale interactions among one or more (and potentially all) components and impurities, influences of the manufacturing factors—e.g. temperature, pressure, heating and cooling histories on the microstructures—microstructure properties, impurity compositions and their relative proportions, and latency effects. These coefficients are not constant and are functions of cᵢ or cᵢⱼ. Hence, Eq. (1) is not an algebraic equation. By definition, the coefficients of an algebraic equation cannot be a function of the independent variables.

Mechanical properties are dependent on both the type of elements and their concentrations. For example, finding an alloy to meet requirements of material properties, alloys are selected with different combinations of M elements and c different concentrations (for example, 4) are tested for each alloy. If the standard trial-and-error approach is used to search in the c_{M} space for the best alloy with the desired mechanical properties, a total of c^{M} tests needs to be performed. For example, if there are M=5 elements and c=4 different concentrations, 1024 tests would be needed. On the contrary, if Eq. 1 is used to find the optimal alloy from M=5 elements, only [1+(M²+3M)/2]=21 tests are needed.

By practising embodiments of the present disclosure, it is possible to search alloys from a pool of M elements to generate a ranked list of mechanical properties of alloys with optimal concentration ratios. Orders of magnitude savings in time, effort and cost are possible.

The microstructure and the thermal expansion coefficient of an alloy are dependent on the manufacturing temperature and the cooling rate. However, the manufacturing process is usually designed after the elements and concentrations of an alloy are chosen, for the reason that searching by the conventional trial-and-error approach is prohibitive in an integrated element-concentration-manufacturing parameter space. With the approach according to the present disclosure, the temperature and cooling rate can be viewed as two “elements” and the number of elements can be slightly increased, resulting in a slightly increased number of tests—[1+(M²+3M)/2]=36—to obtain the optimal solution for an integrated element concentration-manufacturing product.

In alloy manufacturing, each batch of materials delivered from suppliers contains impurities. The composition can be different from batch to batch. Even if the amount is minimal, the effects on the material properties can be significant. Even a very small amount of impurity can affect the formation of microstructures and hence the mechanical properties of the alloy. The types and percentages of impurities will stay the same for the same raw material batch, so their effects on the product's material properties will be constant. With methods and systems according to the present disclosure, it is possible to perform a small number of tests to re-optimise the manufacturing parameters or concentrations of elements for the best mechanical properties—i.e. batch-wise optimisation. This approach can then remove a major uncertainty that leads to non-reproducibility in mass production and laboratory research.

As can be seen from Function (1), the coefficients x₀, xᵢ, xᵢᵢ and xᵢⱼ are each non-constant, in that, in general, they depend on the values of the process parameters themselves, as well as time t. By incorporating such dependence, it is possible to account for latency effects, as well as complex interactions between the process parameters during the alloy manufacturing process.

It will be appreciated that if more than one property is to be optimised, Function (1) may be modified accordingly, with the quantity E then being written as Eₖ, and coefficients x₀ as x₀ₖ, xᵢ as xᵢₖ, etc., with the index k running from 1 to the number of properties.

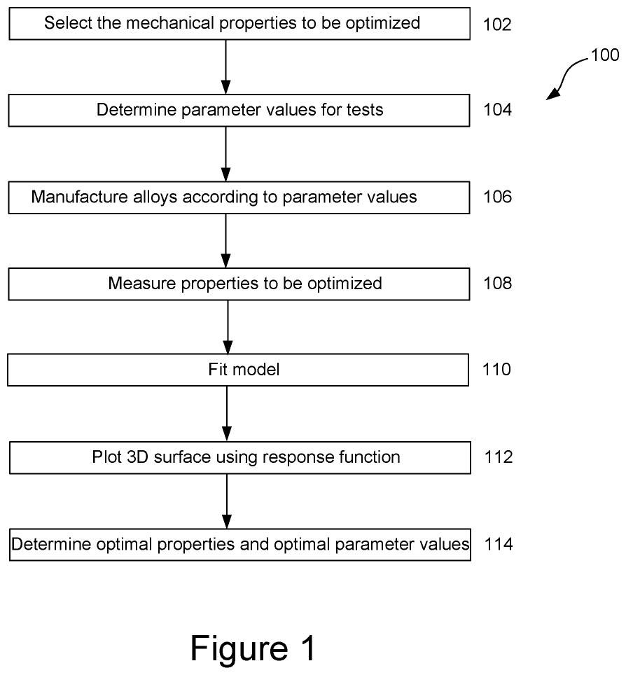

One example of a method 100 consistent with embodiments of the present invention will now be described with reference to FIG. 1. As shown in FIG. 1, an alloy optimisation method 100 may comprise first (step 102) selecting the properties to be optimised. The properties can be any quantitatively measurable properties, e.g., porosity, mechanical properties, surface properties, electronic or magnetic related properties, etc.

Next, at step 104, parameter values for the experimental tests are determined. A parameter space sampling technique (e.g., an experimental design methodology) can guide the selection of a minimal or reduced number of tests to expose salient features of the complex system being evaluated, and to reveal a combination or sub-combination of input parameters of greater significance or impact in affecting a state of the complex system.

In some embodiments, an experimental design methodology can be used to guide the selection of parameter values (element concentrations and process parameter values) for respective experimental tests. In connection with the experimental design methodology, possible parameter values can be narrowed down into a few discrete levels. For example, the tests can be designed such that at least one tested parameter value lies on either side of a peak or maximum in the response surface in order to model the surface as a quadratic function.

In some embodiments, an orthogonal array composite design (OACD) test matrix can be designed based on the selection of parameters and their magnitudes. The OACD will provide the number of tests and the magnitudes of each parameter for each test combination.

At step 106, once the tests have been designed, they are conducted by manufacturing the alloy in accordance with the selected parameter values.

At step 108, the physical properties to be optimised are measured.

Once experimental results of the tests (e.g., in terms of physical properties of the alloy) are available, at step 110, they are fitted into a model by using any suitable multi-dimensional fitting, such as regression analysis. In some embodiments, based on the fitting performance between the experimental results and the model, additional tests can be conducted to improve the accuracy of the model.

In some embodiments, to determine the optimised parameters, the parabolic response surface (PRS) function on the right-hand side of Function (1) is fitted to the measured data to determine the coefficients of the PRS function.

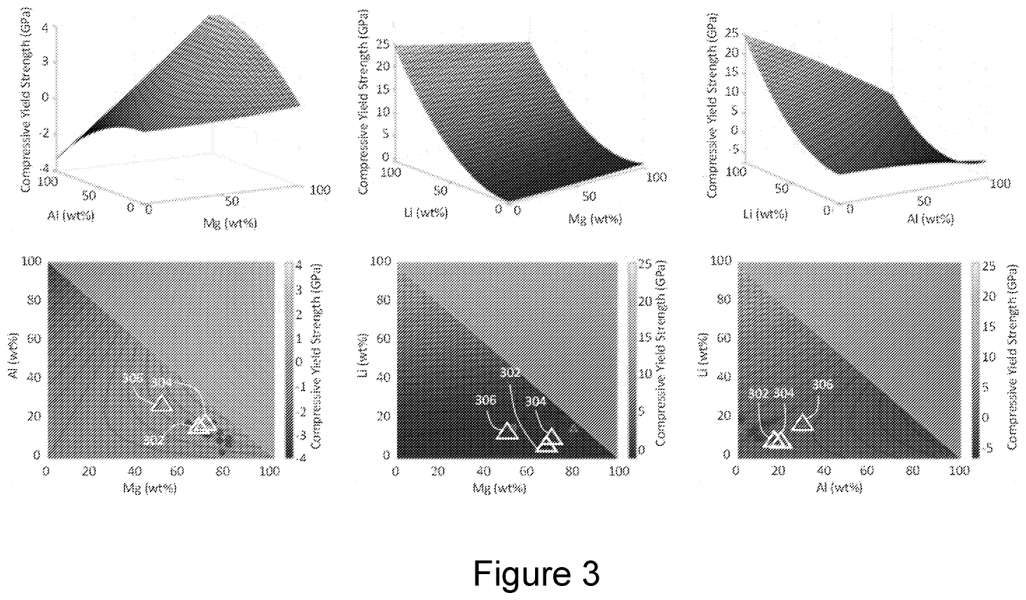

Once the model with a desired accuracy is achieved, optimised combinations of input parameters of the system can be identified by using any suitable extrema locating technique, such as by locating global or local maxima in a response surface whether computationally or from visual inspection of the plots with respect to a design range of parameters, as shown in FIG. 3—e.g. Mg 65%-85%; Al 0%-20%; Li 5%-20%.

For example, at 112, the 3D surface of each property to be optimised may then be plotted using the PRS function, as shown for example in FIG. 3. This may be performed using commercially available analysis and plotting software such as, for example, Python, R, and MATLAB.

Once plotted, the optimal achievable properties and corresponding parameters (alloy component or constituent concentrations and process parameters) on the 3D landscape plot may be determined, at step 114.

Once the optimal parameters are determined, they may be used to manufacture the optimised alloy according to the optimal parameters.

For a different batch of raw material, the optimal parameters are determined after the test alloys are manufactured in a small number of test specimens, preceding the manufacture of a large amount of the alloy. for a different batch of raw material. This may be desirable for industrial-scale manufacturing, since the parameter optimisation process may be carried out using only a small number of test samples (e.g. only 10 test samples for 3 parameters), prior to printing large amounts of alloy that will consume a large amount of material.

In current manufacturing processing the manufacturing parameters, temperature, cooling rate etc, are kept constant and not included in the optimisation procedure due as the trial-and-error method cannot handle a huge search space. With the help of the PRS function, it becomes possible to dynamically optimize the manufacturing parameters to achieve much better mechanical properties.

In some embodiments, experimental data may be used to train the PRS function (1) to determine the relationships between the one or more properties, and the corresponding process parameters. The optimal properties can then be calculated from the PRS function, and the corresponding optimal parameters can be located by reading off from the property-parameter surface plot. The optimal properties may include, but are not limited to, tensile or compressive stresses and strains, thermal or electrical conductivity, and magnetic properties.

Once the test alloys are manufactured and the properties to be optimised are measured, as mentioned above in relation to step 110, the PRS function (1) can be used to fit the resulting data. The PRS is a convoluted surface in a P-dimensional space (where P is the number of parameters). The resulting surface can be used to determine the optimal parameters and the optimal outcomes of the measured properties.

### System for Optimising Alloy Properties

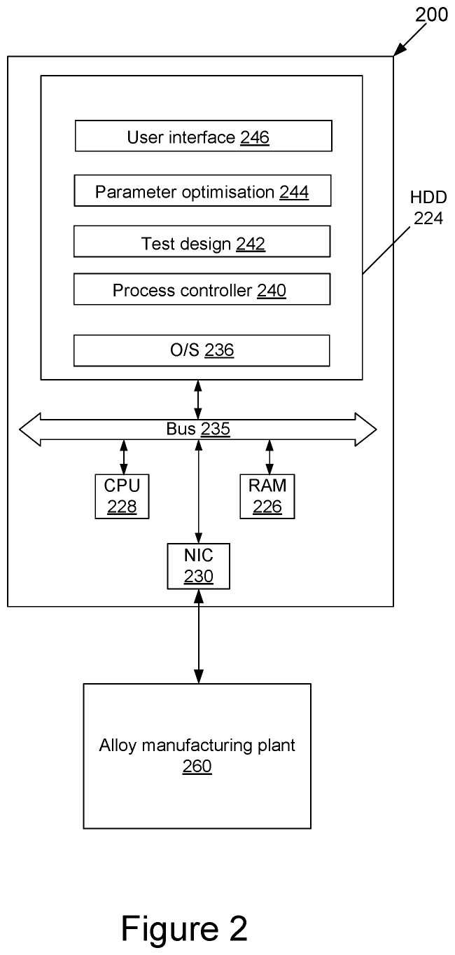

FIG. 2 shows an example architecture of a system 200 for optimising alloy properties. The optimisation system 200 is in communication with an alloy manufacturing plant 260, more specifically with one or more controllers thereof. In some embodiments, the alloy manufacturing plant 260 may form part of the optimisation system 200.

The optimisation system 200 may be implemented as one or more computing devices. The components of the computing device can be configured in a variety of ways. The components can be implemented entirely by software to be executed on standard computer server hardware, which may comprise one hardware unit or different computer hardware units distributed over various locations, which may communicate over a network. Some of the components or parts thereof may also be implemented by application specific integrated circuits (ASICs) or field programmable gate arrays.

In the example shown in FIG. 2, the optimisation system 200 is a commercially available server computer system based on a 32 bit or a 64 bit Intel architecture, and the processes and/or methods executed or performed by the optimisation system 200 are implemented in the form of programming instructions of one or more software components or modules 240, 242, 244, 246 stored on non-volatile (e.g., hard disk) computer-readable storage 224 associated with the optimisation system 200. At least parts of the software modules could alternatively be implemented as one or more dedicated hardware components, such as application-specific integrated circuits (ASICs) and/or field programmable gate arrays (FPGAs).

The optimisation system 200 includes at least one or more of the following standard, commercially available, computer components, all interconnected by a bus 235: random access memory (RAM) 226; at least one computer processor 228, and a network interface connector (NIC) 230 which connects the computer device 200 to a data communications network and/or to external devices, such as alloy manufacturing plant 260.

The optimisation system 200 includes a plurality of standard software modules, including an operating system (OS) 236 (e.g., Linux or Microsoft Windows). The standard software modules may also include standard mathematical modelling or statistical software such as R or MATLAB.

The optimisation system 200 may also include several further software modules or components having specific functions.

For example, optimisation system 200 may include a process controller 240 that is configured to send control signals to alloy manufacturing plant 260 to cause it to manufacture alloys in accordance with input process parameters.

Optimisation system 200 may also include a test design component 242. The test design component 242 may implement an OACD process to generate a plurality of sets of test values of element concentrations and one or more process parameters.

The optimisation system 200 may further include a parameter optimisation component 244. The parameter optimisation component 244 may be configured to receive test data of samples created by the alloy manufacturing plant 260 in accordance with the plurality of sets of test values of the one or more process parameters (e.g. as generated by test design component 242), wherein the test data is indicative of respective measurements of at least one physical property of the test samples for respective sets of test values. The test data may be received by a user uploading measurements for the one or more parameters, or may be automatically obtained from testing equipment (not shown) that is in communication with optimisation system 200 over network interface 230. Further, the parameter optimisation component 244 may be configured to fit the test data to a second-order function that relates at least one property of the test samples (e.g. tensile or compressive stresses and strains, thermal or electrical conductivity, magnetic properties) to the one or more process parameters to determine coefficients of the one or more process parameters. The parameter optimisation component 244 may also be configured to determine, based on the PRS function, optimal values for the one or more process parameters that result in a global optimum for the at least one property.

The computer system 200 may also include a user interface component 246 that generally enables the computer system 200 to receive input from a user, to receive data from the parameter optimisation component 244, and to display results to the user, for example the optimal values of the process parameters that optimise the at least one property of the alloy, and/or one or more 3D surface plots and/or contour plots of the at least one property as a function of two of the parameters (such as shown in FIG. 3).

The boundaries between the modules and components in the software modules 240-246 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the invention. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the blocks of the flow diagrams of the process 100 may be executed by a module (of software modules 240-246) or a portion of a module. The processes may be embodied in a non-transient machine-readable and/or computer-readable medium for configuring a computer system to execute the method. The software modules may be stored within and/or transmitted to a computer system memory to configure the computer system to perform the functions of the module.

The computing device 200 normally processes information according to a program (a list of internally stored instructions such as a particular application program and/or an operating system) and produces resultant output information, e.g. via user interface component 246. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

### EXAMPLES

### Example 1: Optimisation of the Compressive Strengths of a Three-Element Alloy

The applicability of the presently disclosed approach was investigated using three elements (Mg, Al, and Li) and ten concentration ratios. For M=3, the number of coefficients is [1+(M²+3M)/2]=10 in Function (1). Only ten tests are needed, instead of C^{M}=10³=1000 tests. Ten different compositions of MgAlLi alloys were designed by using the OACD method.

The MgAlLi alloys were synthesized using the technique of Disintegrated Melt Deposition (DMD). Magnesium turnings (>99.9% purity, ACROS Organics), aluminium lumps (99.5% purity, Alfa Aesar), and lithium granules (99.999% purity, Alfa Aesar) were used as raw materials for alloy fabrication. The alloying elements were weighed in accordance with the designated chemical composition of the alloys and placed in a graphite crucible. The materials were heated up to 650-700° C. using an electrical resistance furnace and in an atmosphere of inert argon gas. The molten melt was poured through a nozzle of 10 mm diameter at the bottom of the crucible to the mould below the crucible. Two jets of argon gas, oriented normal to the melt stream were used to disintegrate the molten metal before it enters the mould. The disintegrated melt was then deposited into the cylindrical mould of 40 mm diameter. The cast ingot was then removed from the mold and air-cooled.

The cast ingot was machined down from 40 mm to 36 mm diameter to remove the outer layer of the ingot. The ingot was cut into discs of 9 mm height. The disc was then cut into rectangular pieces. The rectangular cast pieces were grinded with sand paper up to 1200 grade. The prepared cast pieces with a dimension of about 8×8×10 mm were used for compression testing. The room temperature compressive tests were performed on the samples in accordance with procedures detailed in the Standard ASTM E9-89a using a fully-automated MTS810 servo-hydraulic test machine. The samples having a width-to-height ratio of 1 for cast alloys were used for compressive testing. The resultant compressive properties of the alloys are listed in Table 1.

TABLE 1
Compressive properties of MgAlLi alloys (Test data).

| | | Compressive | | |
|---|---|---|---|---|
| | | Yield | Peak | |
| Alloy | Composition | Strength | Strength | |
| Designation | (wt. %) | (MPa) | (MPa) | Total Strain |
| R1* | Mg₆₇Al₁₅Li₁₈ | 201 | 1052 | 80 |
| R2* | Mg₆₂Al₁₈Li₂₀ | 181 | 982 | 80 |
| R3* | Mg₇₇Al₃Li₂₀ | 118 | 838 | 80 |
| R4 | Mg₈₀Al₁₀Li₁₀ | 241 | 435 | 12 |
| R5* | Mg₈₀Al₇Li₁₃ | 117 | 768 | 80 |
| R6* | Mg₇₁Al₁₂Li₁₇ | 164 | 1007 | 80 |
| R7* | Mg₇₆Al₉Li₁₅ | 104 | 802 | 80 |
| R8* | Mg₇₀Al₁₂Li₁₈ | 192 | 1079 | 80 |
| R9 | Mg₇₆Al₁₃Li₁₁ | 226 | 410 | 23 |
| R10 | Mg₇₃Al₁₈Li₉ | 413 | 440 | 5 |

*The tests for those alloys stopped (based on machine setting) at 80% reduction. The UCS obtained is at 80% strain.

The compositions and the properties listed in Table 1 were used as the test data for the fitting of Function (1). The results showed that the goodness-of-fit values of compressive yield strength (R²=0.964) and peak strength (R²=0.916) are very high. This means the strengths of the material obtained from the experiments for 3-element alloys matched well with the predictions. The details of the processing results are shown below.

TABLE 2
Compressive Yield Strength

Function (1) (AI-PRS function):
Compressive Yield Strength (MPa) = (−0.000166) + (−0.000434)*Mg% +
(−0.0150)*Al% + (−0.00118)*Li% + 0.0427*Mg%² +
0.665*Mg%*Al% + (−0.751)*Mg%*Li% + (−0.331)*Al%² +
(−1.830)*Al%*Li% + 2.462*Li%²
R² = 0.964 - Test data fit the AI-PRS Function very well
Region 302 in FIG. 3:
Design range: Mg 65%-85%; Al 0%-20%; Li 5%-20%
Maximum = 701 MPa (75% Mg, 20% Al, 5% Li)
Region 304 in FIG. 3:
Design range: Mg 65%-85%; Al 0%-20%; Li 5%-20%
Maximum (R 10) = 413 MPa (73% Mg, 18% Al, 9% Li)
Region 306 in FIG. 3:
Slightly larger than design ranges: Mg 40%-90%; Al 0%-40%; Li 0%-25%
Maximum = 1102 MPa (51% Mg, 32% Al, 17% Li)

In Table 1, R10 (Mg₇₃Al₁₈Li₉) has the highest compressive yield stress of 413 MPa. With the test results, the response surfaces are plotted in FIG. 3 and provide a map to facilitate the search of the compressive yield stress of different compositions of the three elements. A composition of (Mg₇₅Al₂₀Li₅, triangle 302) is very close to the composition of R10 (Mg₇₃Al₁₈Li₉, the triangle 304). The compressive yield stress is 701 MPa, much higher than the R10 yield stress, 413 MPa (Table 2). If searching slightly outside the designed range, a very high compressive yield stress is obtained, 1102 MPa at (Mg₅₁Al₃₂Li₁₇, the triangle 306).

Tests of only 10 specimens can build up a response surface of a three-element alloy. With the help of this four-dimensional map, the compressive yield stress at Mg₇₅Al₂₀Li₅ can be 70% higher than that at the immediately neighboring point (Mg₇₃Al₁₈Li₉). This study fully illustrates the critical attribute of the presently disclosed method. With a very coarse sampling (very small amount of effort) in a high-dimensional space, the presently disclosed method can provide a very fine resolution search and identify the optimal yield stress.

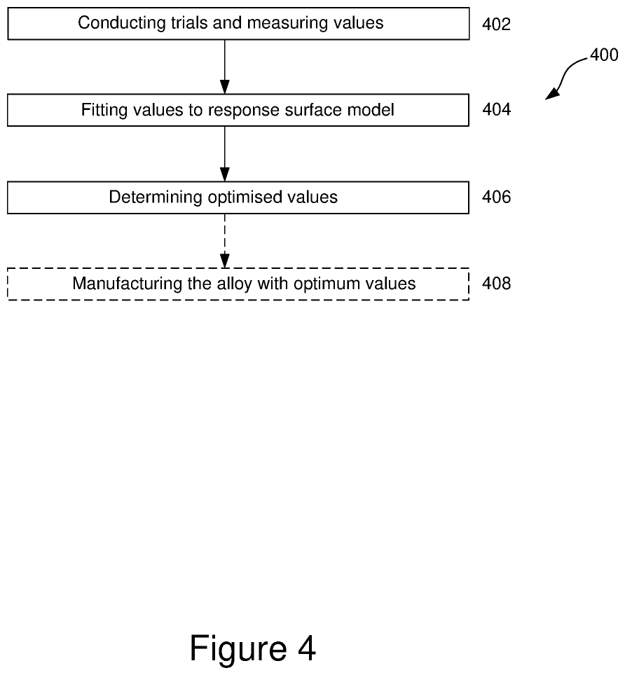

Thus, in experimental set up, the alloys are designed based on mechanical properties and parameters values per steps 102 and 104 of FIG. 1. This results in a group of candidate alloys. Thereafter, at step 106, the candidate alloys are manufactured. The experiments can then be conducted on those alloys as mentioned with respect to steps 108 to 144 and as also set out in FIG. 4. In particular, FIG. 4 shows a method (400) of optimising physical properties of an alloy. In different embodiments a single property may be optimised (e.g. compressive strength) or multiple properties may be optimised (e.g. compressive strength, tensile strain, ductility and others). The alloys are combinations of two metals and thus comprise two or more constituents or alloy components.

The method 400 broadly comprises:
Step 402: conducting a plurality of trials;
Step 404: fitting values measured from the trials conducted at step 402 to a response surface model; and
Step 406: determining optimised values from the response surface model plotted as a result of fitting step 404.

In practice, the optimised values determined at step 406 will be passed to manufacturing plant (260 in FIG. 2) to commence manufacturing of the alloy per step 408.

The trials are conducted per step 402 in accordance with an experimental design, on the plurality of candidate alloys. This is similar to, or the same as, step 108 of FIG. 1. Each trial involves, for each physical property, measuring a plurality of values of the respective physical property of the candidate alloys for different values of a plurality of parameters. The measurements and parameters may have a 1-to-1 relationship (i.e. a single measurement per parameter value), or a many-to-1 relationship (i.e. multiple measurements per parameter value).

In each case, the parameters include a concentration of the two or more constituents and one or more process parameters such as heating rate, cooling rate, holding time, stirring time, solution temperature, solution time, aging temperature, aging time and others. In some cases there will be only a single process parameter of interest and in other cases there may be multiple process parameters of interest which may apply to different processes in the manufacture of an alloy. Thus, a process parameter may be a primary processing parameter such as heating rate, cooling rate and others mentioned above, or may be a secondary processing parameter relating to the fabrication method such as extrusion and rolling. Similarly, for a particular process, a single process parameter may be measured, or multiple process parameters.

Per step 404, the values of the physical property or properties and the plurality of parameters are fitted to a response surface model. This is the same, or similar to, step 110 of FIG. 1. In the response surface model, the parameters are the predictors and the physical properties are the responses—i.e. the parameters of the alloy and its fabrication process dictate the physical properties of the resulting alloy.

The function for response surface modelling may be based on single-objective optimisation such as optimising compressive strength, or multi-objective optimisation such as optimising compressive strength and ductility. That optimisation can occur within design constraints—e.g. there may be a minimum desired ductility, so optimisation may seek to identify the parameters for the alloy having the greatest compressive strength with at least the required ductility. The response surface model may simply be calculated, or may also be plotted. The calculation will depend on the order of the response surface required for optimisation. For a parabolic response surface, the function representing the response surface model is:

∫_{T}_{₀}^{T}E(C,t)dt=∫_{T}_{₀}^{T}x₀(t)dt+Σᵢ₌₁^{M}∫_{T}_{₀}^{T}xᵢ(cᵢ,t)cᵢ(t)dt+Σᵢ₌₁^{M}∫_{T}_{₀}^{T}xᵢᵢ(cᵢᵢ,t)cᵢ²(t)dt+Σᵢ₌₁^{M-1}Σⱼ₌ᵢ₊₁^{M}∫_{T}_{₀}^{T}xᵢⱼ(cᵢⱼ,t)cᵢ(t)cⱼ(t)dt.

The response surface model therefore describes a non-linear relationship between a time integrals of each of the physical property a linear combination of non-linear functions of the plurality of parameters.

From the fitted response surface model, optimised values of the parameters can be determined per step 406, such that they optimise the respective responses.

By using the presently disclosed method, it is possible to reduce the number of initial experiments for input data for the method. Based on the output data, it is possible to narrow down the alloy compositions to achieve the optimal alloy properties.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A method of optimising one or more physical properties of an alloy that comprises two or more constituents, the method comprising:
conducting a plurality of trials in accordance with an experimental design, on a plurality of candidate alloys,
wherein each trial comprises, for each physical property of the one or more physical properties, measuring a plurality of values of the respective physical property of the candidate alloys for different values of a plurality of parameters,
wherein the parameters comprise respective concentrations of the two or more constituents, and one or more process parameters;
fitting the plurality of values of the physical property or properties and the plurality of parameters to a response surface model, in which respective physical properties are respective responses and the parameters are the predictors; and
determining, from the fitted response surface model, optimised values of the parameters that optimise the respective responses;
wherein the response surface model describes a non-linear relationship between a time integral of the physical property and a time integral of a linear combination of non-linear functions of the plurality of parameters.

2. The method according to claim 1, wherein said determining comprises a multi-objective optimisation.

3. The method according to claim 1, wherein the one or more process parameters comprise a plurality of process parameters for a plurality of different processes for generating the candidate alloys.

4. The method according to claim 3, wherein the plurality of different processes comprise one or more primary processing methods and one or more secondary processing methods.

5. The method according to claim 1, wherein the one or more process parameters are selected from the group consisting of: heating rate, cooling rate, holding time, stirring time, solution temperature, solution time, ageing temperature and ageing time.

6. The method according to claim 1, wherein the response surface model is:
∫_{T}_{₀}^{T}E(C,t)dt=∫_{T}_{₀}^{T}x₀(t)dt+Σᵢ₌₁^{M}∫_{T}_{₀}^{T}xᵢ(cᵢ,t)cᵢ(t)dt+Σᵢ₌₁^{M}∫_{T}_{₀}^{T}xᵢᵢ(cᵢᵢ,t)cᵢ²(t)dt+Σᵢ₌₁^{M-1}Σⱼ₌ᵢ₊₁^{M}∫_{T}_{₀}^{T}xᵢⱼ(cᵢⱼ,t)cᵢ(t)cⱼ(t)dt,
where T₀ is a start time, T is a process end time, cᵢ(t) quantifies an i^{th} parameter at time t, cⱼ(t) quantifies a j^{th} parameter at time t, M is a number of parameters and cᵢⱼ(t) represents an interaction between the i^{th} and j^{th} parameters.

7. The method according to claim 1, further comprising manufacturing the alloy in accordance with the optimised values of the parameters.

8. A system for optimising one or more physical properties of an alloy that comprises two or more constituents, the system comprising: one or more processors in communication with computer-readable storage having stored thereon instructions for causing the one or more processors to carry out an optimisation process comprising:
obtaining data from a plurality of trials, that are conducted in accordance with an experimental design, performed on a plurality of candidate alloys, wherein each trial comprises, for each physical property of the one or more physical properties, measuring a plurality of values of the physical property for different values of a plurality of parameters, the plurality of parameters comprising respective concentrations of the two or more constituents and one or more process parameters;
fitting the plurality of values of the physical property and the plurality of parameters to a response surface model, in which the physical property is the response and the parameters are the predictors; and
determining, from the fitted response surface model or fitted response surface models, optimised values of the parameters that optimise the response or the responses;
wherein the response surface model describes a non-linear relationship between a time integral of the physical property and a time integral of a linear combination of non-linear functions of the plurality of parameters.

9. The system according to claim 8, wherein said determining comprises a multi-objective optimisation.

10. The system according to claim 8, wherein the one or more process parameters comprise a plurality of process parameters for a plurality of different processes for generating the candidate alloys.

11. The system according to claim 10, wherein the plurality of different processes comprise one or more primary processing methods and one or more secondary processing methods.

12. The system according to claim 8, wherein the one or more process parameters are selected from the group consisting of: heating rate, cooling rate, holding time, stirring time, solution temperature, solution time, ageing temperature and ageing time.

13. The system according to claim 8, wherein the response surface model is:
∫_{T}_{₀}^{T}E(C,t)dt=∫_{T}_{₀}^{T}x₀(t)dt+Σᵢ₌₁^{M}∫_{T}_{₀}^{T}xᵢ(cᵢ,t)cᵢ(t)dt+Σᵢ₌₁^{M}∫_{T}_{₀}^{T}xᵢᵢ(cᵢᵢ,t)cᵢ²(t)dt+Σᵢ₌₁^{M-1}Σⱼ₌ᵢ₊₁^{M}∫_{T}_{₀}^{T}xᵢⱼ(cᵢⱼ,t)cᵢ(t)cⱼ(t)dt,
where T₀ is a start time, T is a process end time, cᵢ(t) quantifies an i^{th} parameter at time t, cⱼ (t) quantifies a j^{th} parameter at time t, M is a number of parameters and cᵢⱼ(t) represents an interaction between the i^{th} and j^{th} parameters.

14. Non-transitory computer-readable storage having stored thereon instructions for causing one or more processors to carry out an optimisation process comprising:
obtaining data from a plurality of trials that are conducted in accordance with an experimental design to generate a plurality of candidate alloys, wherein each trial comprises, for each physical property of the one or more physical properties, measuring a plurality of values of the physical property for different values of a plurality of parameters, the plurality of parameters comprising respective concentrations of the two or more constituents and one or more process parameters;
fitting the plurality of values of the physical property and the plurality of parameters to a response surface model, in which the physical property is the response and the parameters are the predictors; and
determining, from the fitted response surface model or fitted response surface models, optimised values of the parameters that optimise the response or the responses;
wherein the response surface model describes a non-linear relationship between a time integral of the physical property and a time integral of a linear combination of non-linear functions of the plurality of parameters.

15. The method of manufacturing an alloy, comprising:
determining optimised parameter values by a method according to claim 1; and
manufacturing the alloy in accordance with the optimised parameter values.
